(19) United States
(12) Patent Application Publication
(10) Pub. No.: US 2004/0091743 A1
(43) Pub. Date: May 13, 2004

(54) Magnetoresistance sensor with a controlled-magnetostriction Co-Fe free-layer film

(75) Inventors: Witold Kula, Cupertino, CA (US); Alexander Zeltser, San Jose, CA (US)

Correspondence Address: Ron Feece, IBM Corporation, Intellectual Property Law, 5600 Cottle Road (L2PA/0142), San Jose, CA, 95193, US

(73) Assignee: International Business Machines Corporation, Armonk, NY (US)

(21) Appl. No.: 10/293,462

(22) Filed: Nov. 12, 2002

(51) Int. Cl. B32B 9/00

(52) U.S. Cl. 428/692; 428/693

(57) ABSTRACT

A magnetoresistance sensor structure has a free layer including a Co—Fe free-layer film. The Fe content is from about 12 to about 16 atomic percent, producing a saturation magnetostriction value from about −1×10⁻⁶ to about −2×10⁻⁶. Where the free layer includes only the Co—Fe free-layer film as a ferromagnetic layer, the Fe content of the Co—Fe free-layer film is from about 13 to about 14 atomic percent. Where the free layer has the Co—Fe free-layer film and a Ni-13.5 atomic percent Fe free-layer film, the Fe content is from about 12 to about 16 atomic percent.

This invention relates to a magnetoresistance sensor such as used in the read/write head of a magnetic recording device and, more particularly, to a composition of a Co—Fe free-layer film.

### BACKGROUND OF THE INVENTION

A magnetoresistance (MR) sensor is used in a read/write head to read magnetic fields on a recording medium of a magnetic storage device. An example is the read/write head of a computer hard disk drive or a magnetic recording tape drive. The read/write head is positioned closely adjacent to the recording medium in the case of the computer hard disk drive, separated from the recording medium by an air bearing, or even touching the recording medium. A data bit is written onto an area of the recording medium by locally changing its magnetic state using the writing portion of the read/write head. That magnetic state is later sensed by the MR sensor, which is the reading portion of the read/write head, to read the data bit.

Two known types of MR sensors are a giant magnetoresistance (GMR) sensor and a tunnel magnetoresistance (TMR) sensor. The general technical basis, construction, and operation of the GMR sensor are described, for example, in U.S. Pat. No. 5,436,778. The general technical basis, construction, and operation of the TMR sensor are described, for example, in U.S. Pat. No. 5,729,410. The disclosures of both patents are incorporated by reference in their entireties. These patents also describe the read/write heads and the magnetic storage systems.

The structure of the MR sensors, such as the GMR sensor or TMR sensor, includes two thin-film stacks separated by an intermediate nonmagnetic film. The intermediate nonmagnetic film is typically a copper film or an aluminum oxide film, serving as a spacer layer for the GMR or the TMR sensors, respectively. In one form, the lower thin-film stack includes a transversely (perpendicular to an air bearing surface of the sensor) magnetically pinned structure, and the upper thin-film stack includes a sensing stack with a free layer that responds to an external magnetic field. A longitudinal (parallel to the air bearing surface) magnetic hard biasing structure is present, either as part of the upper thin-film stack or positioned laterally from the thin-film stacks. These stacks may be inverted, as well. A cap layer is deposited over the thin-film stacks.

The magnetic performance of the MR sensor depends upon the character of the free layer, which includes one or more thin free-layer films made of a magnetic material. The saturation magnetostriction λs of the free layer is an important factor in determinating the effective anisotropy field acting upon the free layer, which in turn is critical to achieving high sensitivity and good magnetic stability of the MR sensor. As the free layer is made thinner for better sensitivity, the value of λs of the free layer is undesirably shifted to more positive values. No technique is available for use with a Co—Fe free-layer film to compensate for this positive shift of λs, limiting the ability to make the free layer thinner to improve its sensitivity.

There is a need for an approach for controlling the saturation magnetostriction λs of the free layer containing a Co—Fe free-layer film. The present invention fulfills this need, and further provides related advantages.

### SUMMARY OF THE INVENTION

The present invention provides a structure of, and a method for fabricating, a magnetoresistance (MR) sensor structure in which the free layer includes a Co—Fe (cobalt-iron alloy) free-layer film. The present approach allows the saturation magnetostriction λs of the free layer to be tailored to a selected value depending upon the stress, and particularly to a desirable value usually from about −1×10⁻⁶ to about −2×10⁻⁶ (i.e., negative values). The present approach does not require any change to the remainder of the MR sensor structure or its method of fabrication, and instead allows λs of the Co—Fe free-layer film to be controlled through a variation in composition of the Co—Fe free layer.

In accordance with the invention, a magnetoresistance sensor structure comprises a free layer comprising a Co—Fe free-layer film. The Fe content is from about 12 to about 16 atomic percent. (All compositional percentages herein are in atomic percent, unless stated otherwise.)

Wherein the free layer includes only the Co—Fe free-layer film as a ferromagnetic film, and specifically no Ni—Fe free layer film, the Fe content of the Co—Fe free-layer film is preferably from about 13 to about 14 atomic percent. An example is the layered structure: seed layer/Pt—Mn/Co—Fe/Ru/Co—Fe/Cu/Co—Fe free-layer film/cap.

Where the free layer has the Co—Fe free-layer film and also a Ni—Fe free-layer film, such as a Ni-13.5 atomic percent Fe free-layer film, the Fe content in the Co—Fe free layer film is preferably from about 12 to about 16 atomic percent. An example is the layered structure: seed layer/Pt—Mn/Co—Fe/Ru/CoFe/Cu/Co—Fe free-layer film/Ni—Fe free-layer film/cap.

The present approach is based upon the observation of the dependence of the saturation magnetostriction λs of the free layer Co—Fe film on the composition of the film, and specifically on the atomic percentage of Fe in the Co—Fe free-layer film. The approach may be applied generally in a method for fabricating a magnetoresistance sensor structure having a free layer comprising a Co—Fe free-layer film. The method includes the steps of selecting a magnetoresistance sensor structure including a free layer structure comprising the Co—Fe free-layer film, and providing a design saturation magnetostriction value of the free layer. That is, the desired design saturation magnetostriction for the selected magnetoresistance sensor structure is provided, as an input design parameter. A design Fe content of the Co—Fe free-layer film is selected responsive to the design saturation magnetostriction value and, typically, to the selected magnetoresistance sensor structure. The magnetoresistance sensor structure is fabricated with the Co—Fe free-layer film having the design Fe content. In one preferred case, the design saturation magnetostriction value is from about −1×10⁻⁶ to about −2×10⁻⁶, but the present approach allows other values to be obtained. The various cases and conditions discussed above are applicable here.

The present approach thus provides a technique for establishing the saturation magnetostriction λs of the free layer Co—Fe film at any desired value, and in particular to the range from about −1×10⁻⁶ to about −2×10⁻⁶ in a preferred embodiment.

Other features and advantages of the present invention will be apparent from the following more detailed description of the preferred embodiment, taken in conjunction with the accompanying drawings, which illustrate, by way of example, the principles of the invention. The scope of the invention is not, however, limited to this preferred embodiment.

### BRIEF DESCRIPTION OF THE DRAWINGS

FIG. 1 is a schematic drawing of a bottom MR sensor;

FIG. 2 is a schematic drawing of a first preferred embodiment of the MR sensor of FIG. 1;

FIG. 3 is a schematic drawing of a second preferred embodiment of the MR sensor of FIG. 1;

FIG. 4 is a graph of λs as a function of atomic percent iron, for four upper thin film stacks; and

FIG. 5 is a block diagram of an approach for practicing one aspect of the invention.

### DETAILED DESCRIPTION OF THE INVENTION

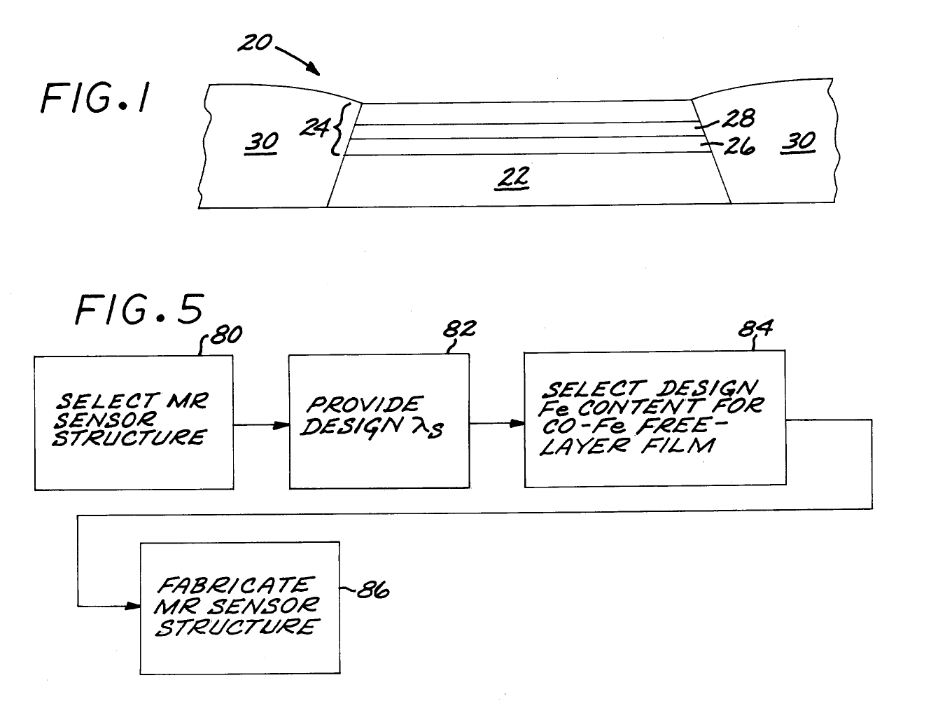

FIG. 1 depicts a bottom MR sensor 20 in general form. The MR sensor 20 includes a lower thin-film stack 22, an upper thin-film stack 24, and a spacer layer 26 between the two stacks 22 and 24. The upper thin-film stack 24 includes a free layer 28 that preforms the actual sensing of an external magnetic field. (The positions of the thin-film stacks 22 and 24 may be reversed to make a top MR sensor.) A longitudinal hard biasing structure 30, typically made of Co—Pt permanent magnetic material, is located laterally adjacent to the thin-film stack 24 (or it may be a part of the upper thin-film stack 24.

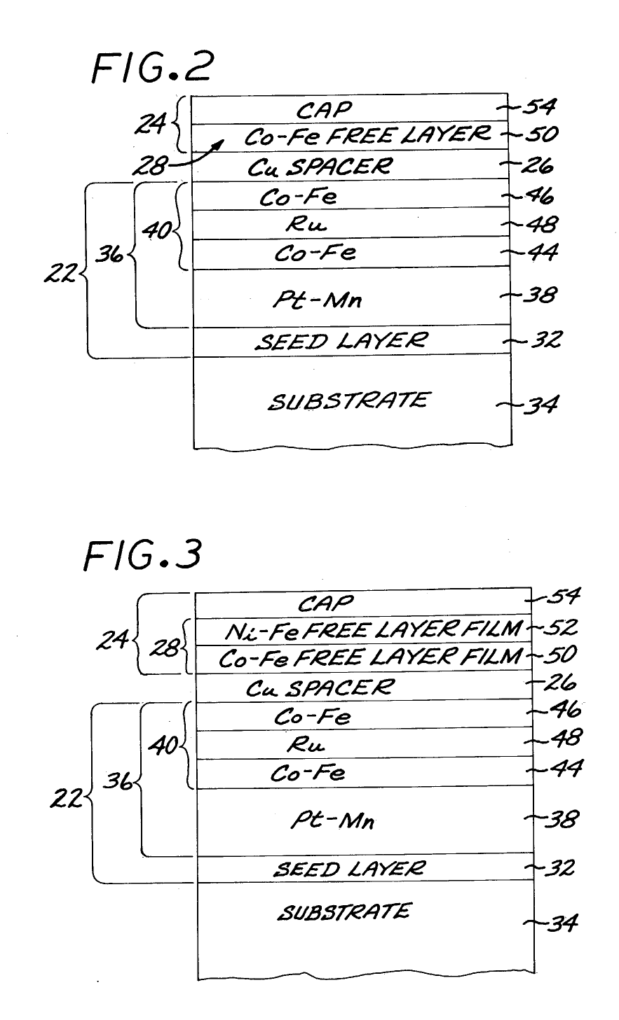

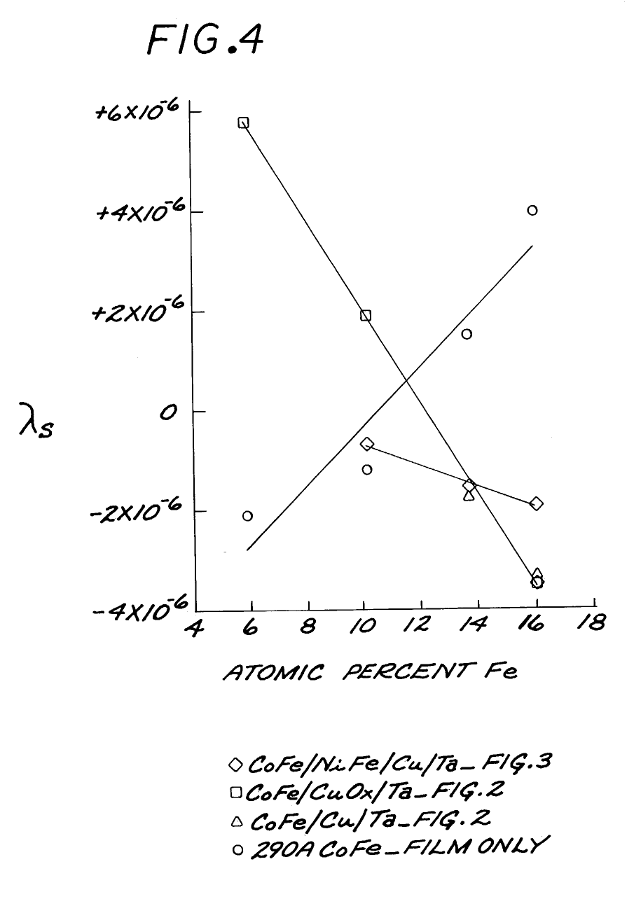

FIGS. 2 and 3 illustrate the physical structure of two preferred forms of the stacked structure of the bottom MR sensor 20. These MR sensors 20 are each giant magnetoresistance (GMR) sensors. In each case, the lower thin-film stack 22 includes a seed layer 32 overlying and contacting a substrate 34, and a transverse biasing stack 36 overlying and contacting the seed layer 32. In a typical case, the seed layer 32 may include a Ni—Fe—Cr film, a Ta film, or a bilayer Ta/Ni—Fe—Cr film, but the use of the present invention is not limited to these seed-layer materials. The seed layer 32 serves as the base upon which the overlying layers are deposited.

The transverse biasing stack 36 overlies and contacts the seed layer 32. The transverse biasing stack 36 includes a transverse pinning layer 38 overlying the seed layer 32, and a transverse pinned layer structure 40 overlying the transverse biasing stack 36. In the illustrated case, the transverse pinning layer 38 is Pt—Mn antiferromagnetic material. The transverse pinned layer structure 40 is formed of two ferromagnetic films 44 and 46, here both depicted as Co—Fe films, separated by a ruthenium (Ru) spacer layer 48. The two ferromagnetic films 44 and 46 are strongly antiparallel exchange-coupled across the ruthenium spacer layer 48. The lower ferromagnetic film 44 adjacent to the transverse pinning layer 38 is sometimes termed the keeper layer, and the upper ferromagnetic film 46 is sometimes termed the reference layer.

The spacer layer 26, preferably Cu or copper-based alloys or reacted forms, overlies and contacts the transverse biasing stack 36. The upper thin-film stack 24 overlies and contacts the spacer layer 26.

The structure of the free layer 28 is different between the embodiments of FIGS. 2 and 3. The free layer 28 of the embodiment of FIG. 2 is a ferromagnetic Co—Fe free-layer film 50. The Co—Fe free-layer film 50 is the only ferromagnetic free-layer film in the free layer. The free layer 28 of the embodiment of FIG. 3 includes the Co—Fe free-layer film 50, and a ferromagnetic Ni—Fe free-layer film 52 overlying and contacting the Co—Fe free-layer film 50. The free-layer film 50 may be partially oxidized prior to the deposition of the cap layer, discussed next. One aspect of the present invention deals with the composition of the Co—Fe free-layer film 50.

A protective cap layer 54 overlies and contacts the free layer 28 in each embodiment. A variety of cap layers 54 may be utilized. The cap layer 54 may be, for example, a Cu or CuOx layer overlying and contacting the free layer 28, and a Ta layer overlying and contacting the Cu or CuOx layer. The cap layer 54 may instead be a Ta layer overlying and contacting the free layer 28.

One of the important design parameters of MR sensors 20 such as those illustrated in FIGS. 1-3 is the saturation magnetization λs of the free layer 28. The ability to control the magnitude and sign of λs is critical for achieving both high sensitivity and good magnetic stability of the MR sensor 20. The effective longitudinal anisotropy field Hₖ acting on the unshielded and isolated free layer depends upon λs according to the relationship

Hₖ=3λs σ/Mₛ+Hᵤ+H_{D},

where Mₛ is the saturation magnetization of the free layer, σ is the anisotropic stress in the free layer, Hᵤ is the induced uniaxial anisotropy of the free layer, and H_{D} is the free layer longitudinal demagnetization field. The deposition of the layers that form the MR sensor 20 creates an isotropic stress in the large-area sheet films. The fabrication of the patterned device to make the read/write head and the lapping of the air bearing surface in the finished device creates an anisotropic compressive stress (i.e., σ<0). It is therefore preferred to have a small negative λs in the range from about −1×10⁻⁶ to −2×10⁻⁶, to maintain a reasonable compromise between high sensitivity and good magnetic stability. Reducing the free layer thickness as required for increasing sensitivity also tends to shift λs toward more positive values due to the increased contribution of the interfacial magnetostriction.

FIG. 4 depicts the test results that lead to the present approach for controlling λs in the Co—Fe free-layer film 50. Structures were fabricated with varying Fe contents of a Co—Fe film, and then tested for λs.

In a first series of tests, a reduction in the Fe content of a 290 Angstrom Co—Fe film (not part of an MR sensor 20) was found to reduce the value of λs. As seen in the following Table 1, the reduction in Fe content in atomic percent also increased the coercivity of the film.

TABLE 1

| At. pct Fe | Hce (Oe) | Hch (Oe) | λs | Cryst. Struct |
|---|---|---|---|---|
| 5.9 | 24.8 | 20.9 | −2.1 × 10-6 | HCP + FCC |
| 10.2 | 21.4 | 19.7 | −1.2 × 10-6 | FCC |
| 13.7 | 13.5 | 9.0 | 1.5 × 10-6 | FCC + BCC |
| 16.1 | 9.9 | 3.4 | 4.0 × 10-6 | FCC + BCC |

The crystal structure (last column) indicates whether the film was hexagonal close packed (HCP), face centered cubic (FCC), or body centered cubic (BCC). The crystal structures of these films varied widely depending upon the composition. The Co—Fe film in the MR sensor 20 is desirably FCC, because HCP Co—Fe has high coercivity and BCC Co—Fe has high positive magnetostriction.

In a second series of tests, MR sensors 20 were prepared with the structure of FIG. 2, having the free layer 28 with the Co—Fe film 50 and with two different types of cap layers 54: Cu/Ta and CuOx/Ta. FIG. 4 shows the value of is as a function of the iron content, and good agreement was found for the sensors with the two different types of cap layers. The following Table 2 reports the properties of the MR sensors as a function of the iron content in atomic percent.

TABLE 2

| At. pct Fe | Rs (Ω/sq) | Hce (Oe) | Hch (Oe) | ΔR/R (pct) | λs |
|---|---|---|---|---|---|
| 5.9 | 21.9 | 13.1 | 12.4 | 12.65 | 5.8 × 10⁻⁶ |
| 10.2 | 23.8 | 5.4 | 2.4 | 13.48 | 1.9 × 10⁻⁶ |
| 13.7 | 23.8 | 5.1 | 5.8 | 13.82 | −1.5 × 10⁻⁶ |
| 16.1 | 23.7 | 6.2 | 2.6 | 13.30 | −3.5 × 10⁻⁶ |

These specimens had a controllable λs while also maintaining good MR sensor properties.

In a third series of tests, MR sensors 20 were prepared with the structure of FIG. 3, having the free layer 28 with both a Co—Fe film 50 and a Ni-13.5 atomic percent Fe film 52, and with a Cu/Ta cap layer 54. FIG. 4 shows the value of λs as a function of the iron content. The following Table 3 reports the properties of the MR sensors as a function of the iron content in atomic percent.

TABLE 3

| At. pct Fe | Rs (Ω/sq) | Hce (Oe) | Hch (Oe) | ΔR/R (pct) | λs |
|---|---|---|---|---|---|
| 10.2 | 21.2 | 4.4 | 2.0 | 13.38 | −6.7 × 10⁻⁷ |
| 13.7 | 20.6 | 3.6 | 1.7 | 13.50 | −1.6 × 10⁻⁶ |
| 16.1 | 21.6 | 3.3 | 3.0 | 13.55 | −1.8 × 10⁻⁶ |

These specimens had a controllable λs while also maintaining good MR sensor properties.

As may be seen most clearly in FIG. 4, in the MR sensors 20 the value of λs increases substantially linearly with decreasing iron content in the range of iron content from about 4 to about 16 atomic percent. However, the slope of the lines differ for the embodiments. If the value of λs is to be in the preferred range from about −1×10⁻⁶ to about −2×10⁻⁶, the Co—Fe free-layer film 50 of the embodiment of FIG. 2 (no Ni—Fe free-layer film) has an Fe content from about 13 to about 14 atomic percent. If the value of λs is to be in the preferred range from about −1×10⁻⁶ to about −2×10⁻⁶, the Co—Fe free-layer film 50 of the embodiment of FIG. 3 (which has the Ni-13.5 atomic percent Fe free-layer film 52) has an Fe content from about 12 to about 16 atomic percent. The Fe content of the Co—Fe free-layer film for embodiments wherein the Ni—Fe free layer film 52 has other Fe compositions depends upon the Fe content of the Ni—Fe free layer film 52.

The present invention thus allows the value of λs to be controllably varied in the Co—Fe free-layer film 50 while maintaining the other desirable properties of the film and the MR sensor. The approach is more broadly applicable than establishing λs in the range from about −1×10⁻⁶ to about −2×10⁻⁶. FIG. 5 depicts a method for fabricating the structure of the magnetoresistance sensor 20 having the free layer comprising the Co—Fe free-layer film 50. First, the desired structure of the magnetoresistance sensor 20, including the free layer structure comprising the Co—Fe free-layer film 50, is selected, numeral 80. For example, the desired structure selected in step 80 may be the embodiment of FIG. 2 (i.e., Co—Fe free-layer film 50 only, and no Ni—Fe free-layer film) or the embodiment of FIG. 3 (i.e., Co—Fe free-layer film 50 and Ni—Fe free-layer film 52).

A design saturation magnetostriction value of the free layer is provided, numeral 82. This is the desired value of λs. In the embodiments discussed earlier, λs is to be in the range from about −1×10⁻⁶ to about −2×10⁻⁶, but this need not be the case. For other situations, there may be reason to select λs with another value within the range possible with the present approach.

A design Fe content of the Co—Fe free-layer film 50 is thereafter selected, numeral 84, responsive to the design saturation magnetostriction value selected in step 82 and to the magnetoresistance sensor structure selected in step 80. This design Fe content is selected from FIG. 4 for the cases illustrated there.

The magnetoresistance sensor 20 is fabricated, numeral 86, with the Co—Fe free-layer film 50 having the design Fe content from step 84. Conventional fabrication techniques known in the art are used for the various layers illustrated in FIGS. 1-3.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A magnetoresistance sensor structure comprising:
a free layer comprising a Co—Fe free-layer film, wherein the Fe content is from about 12 to about 16 atomic percent.

2. The magnetoresistance sensor structure of claim 1, wherein the free layer includes only the Co—Fe free-layer film as a ferromagnetic layer, and wherein the Fe content of the Co—Fe free-layer film is from about 13 to about 14 atomic percent.

3. The magnetoresistance sensor structure of claim 1, wherein the free layer has no Ni—Fe film, and wherein the Fe content of the Co—Fe free-layer film is from about 13 to about 14 atomic percent.

4. The magnetoresistance sensor structure of claim 1, wherein the free layer includes the Co—Fe free-layer film and a Ni—Fe free-layer film.

5. The magnetoresistance sensor structure of claim 1, wherein the magnetoresistance sensor structure comprises the layered structure: seed layer/Pt—Mn/Co—Fe/Ru/Co—Fe/Cu/Co—Fe free-layer film/cap.

6. The magnetoresistance sensor structure of claim 1, wherein the magnetoresistance sensor structure comprises the layered structure: seed layer/Pt—Mn/Co—Fe/Ru/Co—Fe/Cu/Co—Fe free-layer film/Ni—Fe free-layer film/cap.

7. A method for fabricating a magnetoresistance sensor structure having a free layer comprising a Co—Fe free-layer film, the method comprising the steps of
selecting the magnetoresistance sensor structure including a free layer structure comprising the Co—Fe free-layer film;
providing a design saturation magnetostriction value of the free layer;
selecting a design Fe content of the Co—Fe free-layer film responsive to the design saturation magnetostriction value; and
fabricating the magnetoresistance sensor structure, wherein the Co—Fe free-layer film has the design Fe content.

8. The method of claim 7, wherein the step of providing the design saturation magnetostriction value includes the step of
providing the design saturation magnetostriction value from about −1×10⁻⁶ to about −2×10⁻⁶.

9. The method of claim 7,
wherein the step of selecting the magnetoresistance sensor structure includes the step of
selecting the free layer structure comprising the Co—Fe free-layer film and no Ni—Fe film.

10. The method of claim 7,
wherein the step of selecting the magnetoresistance sensor structure includes the step of
selecting the free layer structure comprising the Co—Fe free-layer film and a Ni—Fe free-layer film.

11. The method of claim 7,
wherein the step of selecting the magnetoresistance sensor structure includes the step of
selecting the free layer structure comprising the Co—Fe free-layer film and no Ni—Fe film,
wherein the step of providing the design saturation magnetostriction value includes the step of
providing the design saturation magnetostriction value from about −1×10⁻⁶ to about −2×10⁻⁶,
and wherein the step of selecting the design Fe content includes the step of
selecting the design Fe content of the Co—Fe free-layer film to be from about 13 to about 14 atomic percent.

12. The method of claim 7,
wherein the step of selecting the magnetoresistance structure includes the step of
selecting the free layer structure comprising the Co—Fe free-layer film and a Ni-13.5 atomic percent Fe free-layer film,
wherein the step of providing the design saturation magnetostriction value includes the step of
providing the design saturation magnetostriction value from about −1×10⁻⁶ to about −2×10⁻⁶,
and wherein the step of selecting the design Fe content includes the step of
selecting the design Fe content of the Co—Fe free-layer film to be from about 12 to about 16 atomic percent.

13. The method of claim 7,
wherein the step of selecting the magnetoresistance sensor structure includes the step of
selecting the magnetoresistance sensor structure as seed layer/Pt—Mn/Co—Fe/Ru/Co—Fe/Cu/Co—Fe free-layer film/cap,
wherein the step of providing the design saturation magnetostriction value includes the step of
providing the design saturation magnetostriction value from about −1×10⁻⁶ to about −2×10⁻⁶,
and wherein the step of selecting the design Fe content includes the step of
selecting the design Fe content of the Co—Fe free-layer film to be from about 13 to about 14 atomic percent.

14. The method of claim 7,
wherein the step of selecting the magnetoresistance sensor structure includes the step of
selecting the magnetoresistance sensor structure as seed layer/Pt—Mn/Co—Fe/Ru/Co—Fe/Cu/Co—Fe free-layer film/Ni-13.5 atomic percent Fe free-layer film/cap,
wherein the step of providing the design saturation magnetostriction value includes the step of
providing the design saturation magnetostriction value from about −1×10⁻⁶ to about −2×10⁻⁶,
and wherein the step of selecting the design Fe content includes the step of
selecting the design Fe content of the Co—Fe free-layer film to be from about 12 to about 16 atomic percent.

15. A method for fabricating a magnetoresistance sensor structure having a free layer comprising a Co—Fe free-layer film, the method comprising the steps of
selecting the magnetoresistance sensor structure including a free layer structure comprising the Co—Fe free-layer film;
providing a design saturation magnetostriction value of the free layer from about −1×10⁻⁶ to about −2×10⁻⁶;
selecting a design Fe content of the Co—Fe free-layer film responsive to the design saturation magnetostriction value and to the magnetoresistance sensor structure; and
fabricating the magnetoresistance sensor structure, wherein the Co—Fe free-layer film has the design Fe content.

16. The method of claim 15,
wherein the step of selecting the magnetoresistance sensor structure includes the step of
selecting the free layer structure comprising the Co—Fe free-layer film and no Ni—Fe film,
and wherein the step of selecting the design Fe content includes the step of
selecting the design Fe content of the Co—Fe free-layer film to be from about 13 to about 14 atomic percent.

17. The method of claim 15
wherein the step of selecting the magnetoresistance structure includes the step of
selecting the free layer structure comprising the Co—Fe free-layer film and a Ni-1 3.5 atomic percent Fe free-layer film,
and wherein the step of selecting the design Fe content includes the step of
selecting the design Fe content of the Co—Fe free-layer film to be from about 12 to about 16 atomic percent.

18. The method of claim 15,
wherein the step of selecting the magnetoresistance sensor structure includes the step of
selecting the magnetoresistance sensor structure as seed layer/Pt—Mn/Co—Fe/Ru/Co—Fe/Cu/Co—Fe free-layer film/cap,
and wherein the step of selecting the design Fe content includes the step of
selecting the design Fe content of the Co—Fe free-layer film to be from about 13 to about 14 atomic percent.

19. The method of claim 15,
wherein the step of selecting the magnetoresistance sensor structure includes the step of
selecting the magnetoresistance sensor structure as seed layer/Pt—Mn/CoFe/Ru/Co—Fe/Cu/Co—Fe free-layer film/Ni-13.5 atomic percent Fe free-layer film/cap,
and wherein the step of selecting the design Fe content includes the step of
selecting the design Fe content of the Co—Fe free-layer film to be from about 12 to about 16 atomic percent.
